(19) United States
(12) Patent Application Publication
(10) Pub. No.: US 2004/0258940 A1
(43) Pub. Date: Dec. 23, 2004

(54) Recording sheet and method for recording image using the same

(75) Inventors: Takashi Ogino, Ebina-shi (JP); Tsukasa Matsuda, Ebina-shi (JP); Kiyoshi Hosoi, Ebina-shi (JP); Chizuru Koga, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/869,896

(22) Filed: Jun. 18, 2004

(30) Foreign Application Priority Data
Jun. 23, 2003 (JP) 2003-178245

(51) Int. Cl. B32B 29/00

(52) U.S. Cl. 428/532; 428/537.7

(57) ABSTRACT

The present invention provides a recording sheet which includes regular paper, that contains as a raw material at least a cellulose pulp, having added thereto a nonionic surfactant having an HLB value of higher than 6 and 13 or smaller in an amount of 0.1 g/m² or more. The invention also provides a method for recording an image using the recording sheet.

### CROSS-REFERENCE TO RELATED APPLICATION

This application claims priority under 35 USC 119 from Japanese Patent Application No. 2003-178245, the disclosure of which is incorporated by reference herein.

### BACKGROUND OF THE INVENTION

1. Field of the Invention

The present invention relates to a recording sheet and a method for recording an image using the recording sheet through an ink jet process or an electrophotographic process.

2. Description of the Related Art

Attention has been widely focused on an ink jet process since the ink jet process can be easily adapted for coloration, has little consumption energy and a low noise when recording, and can suppress manufacturing costs of the printer. High quality, high-speed and high-reliability are increasingly advanced. The printing is often performed on the regular paper, and it is extremely important to improve the recording ability on regular paper.

In a conventional ink jet printer, to improve black character image quality and alleviate the problem of inter-color mixing, black ink contains ink that exhibits slow permeability into the sheet by including a pigment as the colorant. Color ink contains ink that exhibits rapid permeability into the sheet by including a dye as the colorant.

As described above, the color ink has improved permeability to the sheet. When an image with high recording density is printed, incidences of curling and waviness occurred immediately after printing become larger, and the sheet jamming and rubbing at an image area occur in the printer. The print productivity is extremely lowered since a time for alleviating curling that occurs immediately after printing and a time for drying ink are necessary when both surfaces are printed. When an image having a high recording density is printed, a problem arises in that curling and waviness generated after being left to stand for drying are large. Therefore, in order to achieve excellent image quality, it is necessary to suppress both curling and waviness at a high degree.

In order to improve curling and waviness after printing, the following methods have been proposed. Curling and waviness are reduced by one-time moistening the sheet and alleviating a stress applied on paper (see, e.g., Japanese Patent Application Laid-Open (JP-A) No. 3-38375).

Curling and waviness are reduced by restricting an in-water expanding ratio in a CD direction of paper (see, e.g., JP-A No. 3-38376).

Curling and waviness are reduced by suppressing the in-water expanding ratios in an MD direction to a CD direction of paper below 1.3 times (see, e.g., JP-A No. 3-199081).

Curling and waviness are reduce by adjusting the in-water expanding ratio in an operating direction of the ink jetting portion to 2.0% or less (see, e.g., JP-A No. 7-276786).

Curling and waviness are reduced by adjusting the in-water expanding ratio in the CD direction to 1.8% or less (see, e.g., JP-A No. 10-46498).

Waviness of a coat-type ink jet recording sheet is reduced by specifying a pigment contained in a support within 5 to 35% by mass and limiting an internal bonding strength of the recording sheet to a range of 150 to 455 g/cm (see, e.g., Japanese Patent No. 3172298).

Further, curling and waviness generated after being left to stand for drying are reduced by specifying an irreversible shrinking ratio in the MD direction and the CD direction at the time of varying relative humidity within a constant range (see, e.g., Japanese Patent No. 3127114).

In the methods disclosed in JP-A Nos. 3-38375, 3-38376, 3-199081, 7-276786, 10-46498, and Japanese Patent No. 3127114, methods for suppressing curling and waviness are set forth. However, since hydrogen bonding is freely formed when ink dries after discharged through an ink jet printer, curling becomes larger and the sheet cannot be used for preparing a document.

In the methods disclosed in Japanese Patent No. 3172298, attempts have been made to reduce flexure generated after printing by controlling an internal bonding strength of a recording sheet on which an ink receiving layer is formed. However, a sufficient effect is not achieved for suppressing curling, waviness and flexure only by controlling the internal bonding strength. Specifically, when a ratio of a maximum value to a minimum value of microwave transmission velocity in the sheet is large, curling grows significantly and thereby the sheet cannot be used for preparing a document.

A method for incorporating an ester nonionic surfactant whose HLB value is 11 or more into an ink absorption layer has been proposed for improving image quality. In the ester nonionic surfactant whose HLB value is 11 or more, in particular 13 or more, ink permeability is excessively high, and the ink penetrates too deeply into the sheet. Therefore, an absolute amount of the fiber which will shrink after dried unavoidably increases as a whole, whereby curling after being left to stand for drying becomes larger. As a result, a sufficient effect is not achieved. In addition, the hydrogen bonding cannot be prevented from re-constructing since hydrophilicity is too high, and curling after being left to stand for drying becomes larger, thus failing to exert a desired effect (see, e.g., JP-A No. 10-278409).

A method for incorporating a surfactant whose HLB value ranges from 3 to 12 into an ink absorption layer has been proposed for improving image quality. However, even if the ink receiving layer contains the surfactant whose HLB value falls within a range of 3 to 12, curling cannot be reduced. Furthermore, when an addition amount of the surfactant is less than 0.1% by mass, and the ink that exhibits rapid permeability in the sheet is used at a large ejecting amount, the discharged amount of the ink becomes large per unit time because of a high printing speed, whereby waviness becomes severer and the sheet cannot be used for preparing a document (see, e.g., JP-A No. 62-144986).

A method for incorporating a bulkiness softener whose HLB value is 6 or less so as to improve bulkiness and flexibility has been proposed. However, since a surfactant having an HLB value of 6 or less, in particular of 4 or less, has poor dispersibility, hydrophilic groups of a base material cannot be fully covered with hydrophobic groups of the surfactant. Thus, the absolute amount of the fiber which expands and shrinks inevitably increases, curling becomes larger, whereby a desired effect is not exerted (see, e.g., JP-A No. 2002-155494).

### SUMMARY OF THE INVENTION

The present invention has been made in view of the above circumstances and provides a recording sheet whose both surfaces can be subjected to printing through an ink jet process, owing to its ability to suppress curling and waviness generated immediately after printing, as well as to suppress curling from being generated even after being left to stand for drying. The present invention also provides a recording sheet which can suppress curling generated immediately after printing when an image is printed through an electrophotographic process. The present invention further provides a method for recording an image using the recording sheet.

A first aspect of the invention is a recording sheet which comprises regular paper, that contains as a raw material at least a cellulose pulp, having added thereto a nonionic surfactant having an HLB value of higher than 6 and 13 or smaller in an amount of 0.1 g/m² or more.

A second aspect of the invention is a method for recording an image on a recording sheet through an ink jet process by discharging ink droplets onto the recording sheet, wherein the recording sheet comprises regular paper, that contains as a raw material at least a cellulose pulp, having added thereto a nonionic surfactant having an HLB value of higher than 6 and 13 or smaller in an amount of 0.1 g/m² or more.

A third aspect of the invention is a method for recording an image on a recording sheet through an electrophotographic process which comprises: uniformly charging a surface of an electrostatic latent image-bearing body; exposing to light the surface of the electrostatic latent image-bearing body to form an electrostatic latent image; developing the electrostatic latent image formed on the surface of the electrostatic latent image-bearing body with a developer for an electrostatic image to thereby form a toner image; transferring the toner image onto the recording sheet; and fixing the transferred toner image, wherein the recording sheet comprises regular paper, that contains as a raw material at least a cellulose pulp, having added thereto a nonionic surfactant having an HLB value of higher than 6 and 13 or smaller in an amount of 0.1 g/m² or more.

### BRIEF DESCRIPTION OF THE DRAWING

FIG. 1 is a schematic view for illustrating a CD expanding and shrinking ratio employed in the present invention.

### DETAILED DESCRIPTION OF THE INVENTION

Hereinafter, the present invention will be described in more detail. The invention provides a recording sheet whose both surfaces can be subjected to printing through an ink jet process, owing to its ability to suppress curling and waviness generated immediately after printing, as well as to suppress curling from being generated even after being left to stand for drying. The invention also provides a recording sheet which can suppress curling generated immediately after printing when an image is printed through an electrophotographic process. The invention further provides a method for recording an image using the recording sheet.

The inventors have conducted intensive research to provide a method capable of suppressing curling generated immediately after printing, suppressing curling from being generated after being left to stand for drying, and also suppressing waviness, through imparting adaptability of both-surface printing to a sheet of regular paper by alleviating flexure of the sheet. The inventors have found that curling and waviness generated immediately after printing is attributed to a rapid swelling of a fibrous layer which has absorbed water present in an aqueous ink. The inventors also found that curling and waviness that occur by shrinkage after being left to stand for drying as a result of de-watering of the fibrous layer that has absorbed the ink, and that ink penetration during a short period of time rapidly advances in a thickness direction of the sheet. The deeper the ink penetrates, the larger the curling and waviness occur after being left to stand for drying.

The inventors have then investigated expanding and shrinking transmission due to absorption/desorption of water present in the fibrous layer that has absorbed the ink. As a result, the inventors have discovered that the expanding and shrinking transmission due to absorption/desorption of water has a significant relation with a expanding and shrinking ratio of the sheet. The inventors also have discovered that expanding and shrinking transmission can be lowered by reducing the expanding and shrinking ratio, and that curling and waviness generated immediately after printing, as well as curling and waviness that occur after being left to stand for drying can both be reduced. Furthermore, the inventors have found that formation of hydrogen bonding is obstructed and the expanding and shrinking ratio is reduced by the presence of a surfactant that has an HLB value falling within a specific range in a sheet base material, whereby curling and waviness can be reduced. The invention was accomplished based on these findings.

As described above, a first aspect of the invention is a recording sheet which comprises regular paper, that contains as a raw material at least a cellulose pulp, having added thereto a nonionic surfactant having an HLB value of higher than 6 and 13 or smaller in an amount of 0.1 g/m² or more.

A second aspect of the invention is a method for recording an image on a recording sheet through an ink jet process by discharging ink droplets onto the recording sheet, wherein the recording sheet comprises regular paper, that contains as a raw material at least a cellulose pulp, having added thereto a nonionic surfactant having an HLB value of higher than 6 and 13 or smaller in an amount of 0.1 g/m² or more.

A third aspect of the invention is a method for recording an image on a recording sheet through an electrophotographic process which comprises: uniformly charging a surface of an electrostatic latent image-bearing body; exposing to light the surface of the electrostatic latent image-bearing body to form an electrostatic latent image; developing the electrostatic latent image formed on the surface of the electrostatic latent image-bearing body with a developer for an electrostatic image to thereby form a toner image; transferring the toner image onto the recording sheet; and fixing the transferred toner image, wherein the recording sheet comprises regular paper, that contains as a raw material at least a cellulose pulp, having added thereto a nonionic surfactant having an HLB value of higher than 6 and 13 or smaller in an amount of 0.1 g/m² or more.

Recording Sheet

The recording sheet of the invention comprises regular paper, that contains as a raw material at least a cellulose pulp, having added thereto a nonionic surfactant having an HLB value of higher than 6 and 13 or less in an amount of 0.1 g/m² or more.

A change in dimensions of the regular paper is reduced by adding thereto the nonionic surfactant whose nonionic surfactant is higher than 6 and 13 or smaller. By addition of the surfactant to the regular paper, curling and waviness generated immediately after printing, as well as curling and waviness generated after being left standing for drying can be reduced when printing is performed through the ink jet process.

The HLB value of the nonionic surfactant is preferably higher than 6 and 11 or smaller, and more preferably higher than 7 and 9 or smaller.

When the HLB value of the nonionic surfactant is higher than 13, ink permeability is excessively high, and hence, the ink penetrates deeply into the sheet at the time of printing through the following ink jet process. Since an absolute amount of the fiber which may shrink after subjected to drying increases as a whole, curling after being left standing for drying becomes larger. Thus, a sufficient effect is not exhibited. Further, re-construction of hydrogen bond cannot be prevented since hydrophilicity is too high. As a result, curling after being left standing for drying becomes larger, whereby a satisfactory effect is not exhibited. When the HLB value of the nonionic surfactant is 6 or smaller, dispersibility of the surfactant is low, and hydrophilic groups in a base material cannot be covered with hydrophobic groups of the surfactant. Since the absolute amount of the fiber which may expand and shrink increases, curling becomes larger and a sufficient effect is not exhibited.

It is necessary that an amount of the nonionic surfactant added to the regular paper is 0.1 g/m² or more. An addition amount is preferably in a range of 0.1 to 5.0 g/m², and more preferably in a range of 0.5 to 3.0 g/m².

When the addition amount of the nonionic surfactant to the regular paper is less than 0.1 g/m², the resultant effect is low and generation of hydrogen bond cannot be prevented. Thus, curling and waviness become larger. If the addition amount of the nonionic surfactant is less than 5 g/m², when printing is performed through the ink jet process, blur of inter-color mixing may take place upon ejecting the ink onto the sheet.

When recording is performed through the ink jet process, (1) printing can be performed on both surfaces of the recording sheet of the invention by suppressing curling and waviness generated immediately after printing, and (2) curling and waviness generated after being left standing for drying can also be suppressed, by the addition of the nonionic surfactant in the above-specified amount to the regular paper.

Examples of the surfactant used in the invention include polyoxyethylene nonylphenyl ether, polyoxyethylene octylphenyl ether, polyoxyethylenedodecylphenyl ether, polyoxyethylene alkylether, polyoxyethylene fatty acid ester, sorbitan fatty acid ester, acetylene glycol ethylene oxide adduct, polyoxyethylene sorbitan fatty acid ester, fatty acid alkylol amide, polyethylene glycol polypropylene glycol block copolymer, polyoxyethylene ether of glycerin ester, and polyoxyethylene ether of sorbitol ester. Among these, acetylene glycol ethylene oxide adduct is preferable.

Examples of the method for adding the nonionic surfactant in an amount of 0.1 g/m² or more to the regular paper include any methods of coating an aqueous solution including the surfactant onto the base paper by a usually employed coating unit, such as a size press, a shim size, a gate roll, a roll coater, a bar coater, an air knife coater, a rod blade coater and a blade coater. The recording sheet of the invention can be obtained after it is subjected to a drying step.

The regular paper of the invention is made of at least a cellulose pulp, and a conventionally known cellulose pulp can be used in the invention. Examples thereof include a cellulose pulp which contains at least a chemical pulp. Examples of the chemical pulp include bleached craft pulp of broadleaf trees, unbleached craft pulp of broadleaf trees, bleached craft pulp of coniferous trees, unbleached craft pulp of coniferous trees, bleached craft sulfite pulp of broadleaf trees, unbleached craft pulp of coniferous trees, pulp made by chemically treating a fiber material such as wood, cotton, hemp and bast fiber.

In addition to the above listed, grand wood pulp obtained by mechanically pulping the wood and chip, chemical and mechanical pulp obtained by impregnating the wood and chip with a chemical solution and by mechanically pulping the wood and chip, and thermo-mechanical pulp obtained by cooking the chip until the chip is slightly softened and by pulping it in a refiner can be used. A virgin pulp may be used singly, or used paper pulp may be added thereto, as necessary.

Specifically, the virgin pulp is preferably bleached by a bleaching method (Elementally Chlorine Free; ECF) which uses chlorine dioxide without using chlorine gas, or a bleaching method (Total Chlorine Free; TCF) which mainly uses ozone/hydrogen peroxide or the like without using chlorine compounds.

Examples of the raw material for the used paper pulp include not-printed paper generated in a book publishing factory, a printing factory and a sheet-cutting factory or the like and includes superior white, special white, inside white and vitiated white; used and printed woodfree paper such as woodfree paper and coated woodfree paper which are printed or copied; used paper printed with an aqueous ink, oily ink and a pencil or the like; old newspaper including handbills such as woodfree paper, coated woodfree paper, mechanical woodpulp paper and mechanical woodpulp coated paper printed; old papers such as mechanical woodpulp, mechanical woodpulp coated paper and natural paper.

The used paper raw material is preferably treated through at least one of an ozone bleaching treatment and a hydrogen peroxide bleaching treatment when the used paper pulp is employed in the recording sheet of the invention. The blending ratio of the used paper pulp obtained after the bleaching treatment is preferably in a range of 50 to 100% to give a sheet having higher whiteness. The blending ratio of the used paper pulp is more preferably in a range of 70 to 100% in view of usage as the recycling resource. The ozone treatment may decompose the fluorescent dye or the like usually included in the woodfree paper, and the hydrogen peroxide treatment may prevent yellowing due to the alkali used at a de-inking treatment. Specifically, it is known that de-inking of the used paper is facilitated and whiteness of the pulp is improved by combining the two treatments. Since such a treatment contributes to decompose and remove the remaining chlorine compound in the pulp, the content of an organic halogen compound is considerably reduced in the used paper which uses the pulp and is bleached by chlorine.

In the recording sheet of the invention, a polyvalent metal salt is preferably added to the regular paper. If the regular paper contains the polyvalent metal salt and the ink for ink jet contains an anionic polymer when an image is printed through the ink jet process, significantly rapid agglomeration of the colorant is achieved by crosslinking the anionic polymer, whereby an excellent print image quality can be obtained. In addition, since penetration of the ink solvent into the sheet is suppressed, incidences of curling and waviness generated immediately after printing, and curling and waviness to occur after being left standing for drying can also be improved.

Chlorides, sulfates, nitrates, formates, acetates or the like of potassium, barium, calcium, magnesium, zinc, tin, manganese, aluminum and the other polyvalent metals can be used as the polyvalent metal salt. Specific examples thereof include barium chloride, calcium chloride, calcium acetate, calcium nitrate, calcium formate, magnesium chloride, magnesium sulfate, magnesium nitrate, magnesium acetate, magnesium formate, zinc chloride, zinc sulfate, zinc nitrate, zinc formate, tin chloride, tin nitrate, manganese chloride, manganese sulfate, manganese nitrate, manganese formate, aluminium sulfate, aluminium nitrate, aluminium chloride, and aluminium acetate. These polyvalent metal salts may be used singly or in combination thereof. Among the polyvalent metal salts, metal salts having high solubility in water and a high valence are preferable. When the counter ion of the polyvalent metal salt is a strong acid, yellowing of the sheet after coating has been applied will readily occur. Preferable examples of the polyvalent metal salts include calcium chloride, calcium formate, magnesium chloride and magnesium formate.

The adding amount of the polyvalent metal salt to the regular paper is preferably in a range of 0.1 to 2.0 g/m², and more preferably in a range of 0.5 to 1.0 g/m².

The content of the polyvalent metal salt in an amount of less than 0.1 g/m² may suppress a reaction with the pigment and the anion polymer present in the ink when the ink jet process is employed. As a result, image quality may be lowered, and curling and waviness immediately after printing, and curling and waviness after being left standing for drying may become seriously larger. In contrast, when the content of the polyvalent metal salt is more than 2.0 g/m², permeability of the ink may be impaired, thereby possibly deteriorating ink dryness during a high-speed printing.

The polyvalent metal salt can be added by applying coating onto a surface of the regular paper when the recording sheet is manufactured. Although a coating solution obtained by dissolving the polyvalent metal salt in water may be directly applied to the regular paper when applying coating, the coating solution is generally applied by mixing the polyvalent metal salt with the binder.

As the binder, oxidized starch, phosphate-esterified starch, modified starch, cationic-modified starch or variously modified starches; polyethylene oxide, polyacrylamide, sodium polyacrylate, sodium alginate, hydroxymethylcellulose, carboxymethyl cellulose, methyl cellulose, polyvinyl alcohol and the derivatives thereof can be used singly or in combination thereof, however, the invention is not limited thereto.

In the invention, a filler is preferably added to the regular paper to suitably adjust opacity, whiteness and surface properties. Specifically, when it is desired to reduce the content of halogen in the recording sheet, the filler which does not contain any halogen is preferably used. The examples of the usable filler include a white inorganic pigment such as heavy calcium carbonate, light calcium carbonate, chalk, kaolin, calcined clay, talc, calcium sulfate, barium sulfate, titanium dioxide, zinc oxide, zinc sulfide, zinc carbonate, aluminum silicate, calcium silicate, magnesium silicate, synthetic silica, aluminium hydroxide, alumina, sericite, white carbon, saponite, calcium montmorillonite, sodium montmorillonite, bentonite; an organic pigment such as acrylic plastic pigment, polyethylene and a urea resin. When the used paper is mixed therewith, the addition amount of the used paper is preferably adjusted by previously estimating an ash content in the used paper raw material.

An internal sizing agent is preferably added to the base paper of the invention. A neutral rosin sizing agent usable for a neutral paper, alkenyl succinic anhydride (ASA), alkylketenedimer (AKD), and a petroleum resin sizing agent may be used as the internal sizing agent. A sizing degree of the sheet before applying a coating of the cation resin preferably ranges from 10 seconds to 60 seconds, such that penetration of a cationic resin into the sheet can be suppressed.

The CD expanding and shrinking ratio, to be described below, of the recording sheet of the invention preferably ranges from 0.25 to 0.50%, and more preferably in a range of 0.25 to 0.45%, and more preferably in a range of 0.25 to 0.40%.

The CD expanding and shrinking ratio can be adjusted by incorporating the nonionic surfactant.

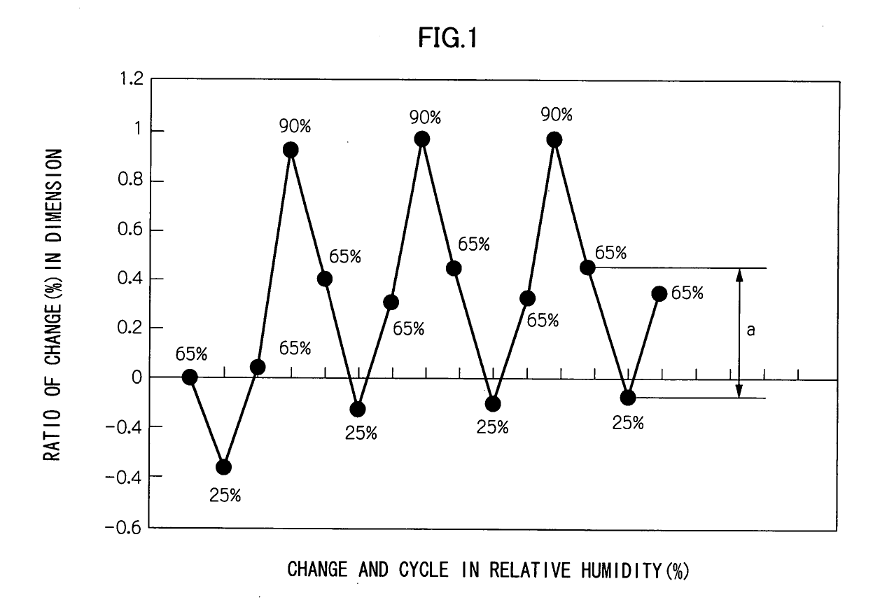

The “CD expanding and shrinking ratio” of the invention will be described with reference to FIG. 1. FIG. 1 is a schematic view for illustrating CD expanding and shrinking ratio employed in the invention. As used herein, “CD expanding and shrinking ratio” refers to a ratio of change in dimension of the recording sheet. Incidentally, “a” shown in FIG. 1 indicates a ratio of change in dimension when repetitive absorption/desorption moistening treatment is performed in which humidity is changed in a manner of “65% R.H.→25% R.H.→65% R.H.→90% R.H.”, in three cycles as shown in FIG. 1, at the time of leaving the recording sheet standing at a constant temperature of 23° C., and then humidity is changed in another manner of “65% R.H.→25% R.H.” at the third cycle. The size of the recording sheet is measured using H·K type expanding and shrinking level test device manufactured by Oji Engineering Co., Ltd.

As used herein, “CD (direction)” means a direction to which a flowing direction at the time of manufacturing the recording sheet is perpendicularly crossed. When a size of the recording sheet is measured, the size in the direction to which the flow direction at the time of manufacturing the recording sheet is perpendicularly crossed is measured.

A basis weight of the recording sheet of the invention is preferably in a range of 60 to 128 g/m², more preferably in a range of 60 to 100 g/m², and particularly preferably in a range of 60 to 90 g/m². The recording sheet having a basis weight of higher than the above is more advantageous in view of suppressed curling and waviness. The higher the basis weight, the more suppressed waviness obtained. When the basis weight is more than 128 g/m², running ability of the printer may be impaired.

In contrast, when the basis weight is less than 60 g/m², it may be difficult to suppress incidences of curling and waviness, and occurrence of off-set may also be increased.

Method for Recording Image

Hereinafter, the method for recording the image of the invention will be explained. The method of recording the image of the invention may be either a method for recording an image through the ink jet process described below or a method for recording an image through the electrophotographic process. However, the method of recording the image of the invention is preferably a method employing the ink jet process in view of ability to obtain the document having higher quality.

First, the method of recording the image through the ink jet process (hereinafter occasionally referred to as “method of ink jet recording”) will be described.

The method of ink jet recording of the invention comprises discharging droplets of ink for ink jet (hereinafter occasionally referred to as “ink”) onto the recording sheet, and recording the image on the recording sheet.

The ink used for the method of recording the image of the invention is not particularly limited, insofar as the ink is a known ink containing at least a colorant. The ink which contains the colorant and an anionic water-soluble polymer, a water-soluble organic solvent and water as the essential components is preferable. The ink may further contain a pigment dispersant, a surfactant and various additives or the like. Respective components will be described in detail below.

The colorant used for the ink may be a water-soluble dye, an organic pigment and an inorganic pigment.

When the ink is black ink, it is preferable that the ink mainly contains a pigment. Examples of the black pigment include carbon black pigments such as furnace black, lamp black, acetylene black and channel black. Specific examples include Raven 7000, Raven 5750, Raven 5250, Raven 5000 ULTRA II, Raven 3500, Raven 2000, Raven 1500, Raven 1250, Raven 1200, Raven 1190 ULTRA II, Raven 1170, Raven 1255, Raven 1080, and Raven 1060 (manufactured by Columbian D Chemicals Company); Regal 400R, Regal 330R, Regal 660R, Mogul L, BlackPearlsL, Monarch 700, Monarch 800, Monarch 880, Monarch 900, Monarch 1000, Monarch 1100, Monarch 1300, and Monarch 1400 (manufactured by Cabot Corporation); Color Black FW1, Color Black FW2, Color Black FW2V, Color Black 18, Color Black FW200, Color Black S150, Color Black S160, Color Black S170, Printex 35, Printex U, Printex Vrintex 140U, Printex 140V, Special Black 6, Special Black 5, Special Black 4A, Special Black 4 (manufactured by Degussa); No. 25, No. 33, No. 40, No. 47, No. 52, No. 900, No. 2300, MCF-88, MA600, MA7, MA8 and MA100 (manufactured by Mitsubishi Chemistry Co., Ltd.).

Although it is difficult to generally discuss a suitable feature of carbon black, a particle diameter thereof is preferably in a range of 15 to 30 nm; a BET surface area ranges from 70 to 300 m²/g; a DBP oil absorption ranges from 0.5 to 1.0×10⁻³ L/g; a volatile content ranges from 0.5 to 10% by mass, and an ash content ranges from 0.01 to 1.00% by mass. If carbon black outside the above-indicated ranges is used, a dispersed particle diameter may become larger in the ink.

The colorants to be used when the ink is cyan, magenta, or yellow ink are not limited to dyes. For example, a pigment which has acquired hydrophilicity by adding to a hydrophobic pigment a dispersant that contains a hydrophilic group, and a self-dispersible pigment can be preferably used.

A known water-soluble dye or another water-soluble dye that is newly synthesized may be used as the water-soluble dye. Among these, a direct dye or an acid dye capable of developing bright color is preferable. Specific examples thereof include C.I. direct blue 1, -2, -6, -8, -22, -34, -70, -71, -76, -78, -86, -142, -199, -200, -201, -202, -203, -207, -218, -236 and -287; C.I. direct red-1, -2, -4, -8, -9, -11, -13, -1, -20, -28, -31, -33, -37, -39, -51, -59, -62, -63, -73, -75, -80, -81, -83, -87, -90, -94, -95, -99, -101, -110 and -189; C.I. direct yellow-1, -2, -4, -8, -11, -12, -26, -27, -28, -33, -34, -41, -44, -48, -86, -87, -88, -135, -142 and -144; C.I. acid blue-1, -7, -9, -15, 22, -23, -27, -29, -40, -43, -55, -59, -62, 78, -80, -81, -90, -102, -104, -111, -185 and -254; C.I. acid red -1, -4, -8, -13, -14, -15, -18, -21, -26, -35, -37, -249 and -257; C.I. acid yellow-1, -3, -4, -7, -11, -12, -13, -14, -19, -23, -25, -34, -38, -41, -42, -44, -53, -55, -161, -71, -76 and -79. These may be used singly or in combination thereof.

Examples of the cationic dye include C.I. basic yellow-1, -11, -13, -19, -25, -33, -33 and -36; C.I. basic red-1, -2, -9, -12, -13, -38, -39 and -92; C.I. basic blue-1, -3, -5, -9 and -19; C.I. -24, -25, 26 and 28.

Specific examples of the cyan color pigment include C.I. Pigment Blue-1, C.I. Pigment Blue-2, C.I. Pigment Blue-3, C.I. Pigment Blue-15, C.I. Pigment Blue-15: 1, C.I. Pigment Blue-15: 3, C.I. Pigment Blue-15: 34, C.I. Pigment Blue-16, C.I. Pigment Blue-22, and C.I. Pigment Blue-60.

Specific examples of the magenta color pigment include C.I. Pigment red 5, C.I. Pigment red 7, C.I. Pigment red 12, C.I. Pigment red 48, and C.I. Pigment red 48: 1, C.I. Pigment red 57, C.I. Pigment red 112, C.I. Pigment red 122, C.I. Pigment red 123, C.I. Pigment red 146, C.I. Pigment red 168, C.I. Pigment red 184 and C.I. Pigment red 202.

Specific examples of the yellow color pigment include Pigment Yellow-1, C.I. Pigment Yellow-2, C.I. Pigment Yellow-3, C.I. Pigment Yellow-12, C.I. Pigment Yellow-13, C.I. Pigment Yellow-14, C.I. Pigment Yellow-16, C.I. Pigment Yellow-17, C.I. Pigment Yellow-73, C.I. Pigment Yellow-74 and C.I. Pigment Yellow-75, C.I. Pigment Yellow-83, C.I. Pigment Yellow-93, C.I. Pigment Yellow-95, C. Pigment Yellow-97, C.I. Pigment Yellow-98, C.I. Pigment Yellow-114, C.I. Pigment Yellow-128, C.I. Pigment Yellow-129, C.I. Pigment Yellow-151 and C.I. Pigment Yellow-154.

As described above, a pigment (a self-dispersible pigment) which can be self-dispersed in water may be used as the pigment for use in the invention. The self-dispersible pigment as used herein refers to the pigment which has a large number of groups having solubility in water at a surface thereof and can stably be dispersed even if the pigment dispersant is not present. Specifically, a self-dispersible pigment can be obtained by applying a surface modifying treatment such as a acid-base treatment, a coupling agent treatment, a polymer-graft treatment, a plasma treatment or an oxidation/reduction treatment to a usually employed pigment. In addition to the surface-modified self-dispersible pigments, cab-o-jet-200, cab-o-jet-300, IJX-55, IJX-253, IJX266 and IJX-273 manufactured by Cabot Corporation, Nicrojet Black CW-1 manufactured by Orient Chemical Industries, Ltd., and pigments or the like available from Nippon Shokubai Co., Ltd. may be used.

The group having solubility in water and present at a surface of the self-dispersible pigment may be nonionic, cationic or anionic. However, sulfonic acid, carboxylic acid, hydroxyl group and phosphoric acid are specifically preferable. The sulfonic acid, the carboxylic acid or phosphoric acid can be used in the state of a free acid as it is. However, the acid is preferably used in the form of a salt obtained with a basic compound so as to improve water solubility.

In this case, alkaline metals such as sodium, potassium and lithium, fatty amines such as monomethylamine, dimethylamine and triethylamine, alcoholic amines such as monomethanol amine, monoethanol amine, diethanol amine, triethanol amine and diisopropanolamine, and ammonia can be used as the basic compound. Among these, in particular, the basic compounds of the alkaline metals such as sodium, potassium and lithium can be preferably used. The reason therefor may be considered that the basic compounds of the alkali metal are strong electrolyte and an effect for facilitating dissociation of acid radicals is significantly exerted.

When the ink includes the pigment as the colorant, the content of the pigment is preferably in a range of 0.5 to 20% by mass in the ink, and more preferably in a range of 2 to 10% by mass. The content of the pigment of less than 0.5% by mass may reduce optical density. The content of the pigment of more than 20% by mass may impair image fixation.

In contrast, when the ink contains the dye as the colorant, a content of the dye is preferably in a range of 0.1 to 10% by mass, more preferably in a range of 0.5 to 8% by mass, and more preferably in a range of 0.8 to 6% by mass. When the content of the dye is more than 10% by mass, clogging may easily occur at a tip of a print head. When the content of the dye is less than 0.1% by mass, a sufficient image density cannot be obtained.

As the anionic water-soluble polymer, for examples, acids such as carboxylic acid and sulfonic acid, the derivatives thereof, and an anionic polymer emulsion may be mentioned. An anionic dispersant to be described below may also be mentioned.

Specific examples of the carboxylic acid include formic acid, acetic acid, propionic acid, butyric acid, valeric acid, lactic acid, tartaric acid, benzoic acid, acrylic acid, crotonic acid, butenic acid, methacrylic acid, tiglic acid, allylic acid, 2-ethyl-2-butenic acid, oxalic acid, malonic acid, amber acid, glutaric acid, maleic acid, fumaric acid, methyl maleic acid, glyceric acid, their polymers and their derivatives. The alkali metal salt, the alkali earth metal salt and the ammonium salt or the like of these compounds can be used.

Specific examples of the sulfonic acid include benzenesulfonic acid, toluenesulfonic acid, xylene sulfonic acid, benzenedisulfonic acid, benzenetrisulfonic acid, hydroxy benzenesulfonic acid, chlorobenzene sulfonic acid, bromobenzenetrisulfonic acid, 4-hydroxy-1,3-benzenedisulfonate, 4,5-dihydroxybenzen-1,3-dihydroxybenzene-1,3-disodium sulfonate, o-aminobenzene sulfone acid, the derivatives thereof, their alkali metal salts, their alkali earth metal salts and their ammonium salts.

These compounds are preferably used in the form of a salt obtained with a basic compound so as to improve water solubility. Alkali metals such as sodium, potassium and lithium; fatty amines such as monomethylamine, dimethylamine and triethylamine; alcoholic amines such as monomethanolamine, monoethanolamine, diethanolamine, triethanol amine and diisopropanolamine; ammonia or the like can be used as the components for forming these compounds and these salts.

Preferable examples of the anionic water-soluble polymer include acrylate alkyl ester/acrylate copolymer, styrene/methacrylate alkyl ester/methacrylate copolymer, styrene/maleic acid copolymer, styrene/methacrylate copolymer, styrene/acrylate copolymer, methacrylate alkyl ester/methacrylate copolymer, styrene/acrylate alkyl ester/acrylate copolymer, styrene/methacrylate phenyl ester/methacrylate copolymer, styrene methacrylate cyclohexyl ester/methacrylate copolymer, the salts and the derivatives of their copolymer.

The anionic water-soluble polymer included in the ink has preferably a structure consisting of a hydrophilic moiety and a hydrophobic moiety, and more preferably contains carboxylic acid or the salt of the carboxylic acid as the functional group to form the hydrophilic moiety.

Specifically, a monomer to form the hydrophobic moiety is preferably one kind or more that is selected from acrylate, methacrylate and (anhydrous) maleic acid to construct the anionic water-soluble polymer.

Examples of the monomer to form the hydrophobic moiety of an anionic compound include styrene derivative such as styrene, α-methyl styrene and vinyl toluene, vinyl cyclohexane, vinyl naphthalene, vinyl naphthalene derivative, acrylate alkyl ester, methacrylate alkyl ester, methacrylate phenyl ester, methacrylate cyclo alkyl ester, alkyl ester crotonate, dialkyl ester itaconate and dialkyl ester maleate. Among these, one kind or more selected from styrene, alkyl, aryl and alkylaryl ester of (meth)acrylate is preferable.

These anionic water-soluble polymers may be used singly or in combination. The content of the anionic water-soluble polymer is preferably in a range of 0.1 to 10% by mass in the ink, and more preferably in a range of 0.3 to 5% by mass. When the content of the anionic water-soluble polymer is less than 0.1, the ink may be inferior in long-term storability and optical density may be impaired. When the content of the anionic water-soluble polymer is more than 10% by mass, the ink cannot be sprayed normally, and optical density may be lowered.

Examples of the water-soluble organic solvent include polyvalent alcohols such as ethylene glycol, diethylene glycol, propylene glycol, butylene glycol, triethylene glycol, 1,5-pentanediol, and 1,2,6-hexanetriol and glycerin; polyvalent alcohol derivatives such as ethylene glycol monomethyl ether, ethylene glycol monoethyl ether, ethylene glycol monobutylether, diethylene glycol monomethyl ether, diethylene glycol monoethyl ether, diethylene glycol monobutyl ether, propylene glycol monobutyl ether and dipropylene glycol monobutyl ether; nitrogen-containing solvents such as pyrrolidone, N-methyl-2-pyrrolidone, cyclohexyl pyrrolidone and triethanol amine; alcohols such as ethanol, isopropyl alcohol, butyl alcohol and benzyl alcohol; sulfur-containing solvents such as thiodiethanol, thiodiglycerol, sulfolane and dimethyl sulfoxide; propylene carbonate and ethylene carbonate. These water-soluble organic solvents may be used singly or in combination thereof.

A content of the water-soluble organic solvent in the ink is preferably in a range of 1 to 60% by mass, and more preferably in a range of 5 to 40% by mass. When the content of the water-soluble organic solvent is less than 1% by mass, the ink may be inferior in long-term storability. When the content of the water-soluble organic solvent is more than 60% by mass, discharging stability may be reduced, and the ink may not be discharged normally.

Ion exchanged water, distilled water, purified water and ultra-pure water or the like can be used as water for preparing the ink.

The content of the water in the ink is preferably in a range of 15 to 98% by mass, and more preferably in a range of 45 to 90% by mass. When the content of the water is less than 15% by mass, discharging stability may be reduced, and the ink may not be discharged normally. When the content of the water is more than 98% by mass, the ink may be inferior in long-term storability.

A pigment dispersant can be used for dispersing the pigment in the ink. Examples of the pigment dispersants include a polymer dispersant, an anionic surfactant, a cationic surfactant, an amphoteric surfactant, and a nonionic surfactant.

Among these pigment dispersants, in the invention, the pigment dispersant which becomes an organic negative ion when ionized in water may be used as an anionic pigment dispersant. The anionic water-soluble polymers described above can be used as the anionic pigment dispersant.

Any polymer dispersant having a hydrophilic moiety and a hydrophobic moiety can be effectively used. Examples of the polymer having the hydrophilic moiety and the hydrophobic moiety include a condensation polymer and an addition polymer.

Examples of the condensation polymers include a known polyester dispersant. Examples of the addition polymer include an addition polymer of a monomer having a α, β-ethylenically unsaturated group. A desired polymer dispersant can be obtained by copolymerizing through appropriately combining a monomer which has the α, β-ethylenically unsaturated group having the hydrophilic group with another monomer which has the α, β-ethylenically unsaturated group having the hydrophobic group. Also, a homopolymer of a monomer which has the α, β-ethylenically unsaturated group having the hydrophilic group can be used.

The examples of the monomer which has the α, β-ethylenically unsaturated group having the hydrophilic group include monomers having a carboxyl group, a sulfonic group, a hydroxyl group, a phosphate group or the like. Specific examples thereof include acrylate, methacrylate, crotonic acid, itaconic acid, monester itaconate, maleic acid, monester maleate, fumaric acid, monester fumarate, divinyl sulfonic acid, styrene sulfonic acid, sulfonated vinyl naphthalene, vinyl alcohol, acrylamide, methacryloxyethyl phosphate, bis-methacryloxyethyl phosphate, methacrylooxyethyl phenylacidphosphate, ethylene glycol dimetacrylate, and diethylene glycol dimetacrylate.

On the other hand, examples of the monomer which has the α, β-ethylenically unsaturated group having the hydrophobic group include styrene derivatives such as styrene, α-methyl styrene and vinyl toluene, vinyl cyclohexane, vinyl naphthalene, vinyl naphthalene derivatives, alkyl ester acrylate, phenyl ester acrylate, alkyl ester methacrylate, phenyl ester methacrylate, cycloalkyl ester methacrylate, alkyl ester crotonate, dialkylester itaconate, and dialkylester maleate.

Preferable examples of the copolymer of these monomers include styrene/styrene sulfonate copolymer, styrene/maleate copolymer, styrene/methacrylate copolymer, styrene/acrylate copolymer, vinyl naphthalene/maleate copolymer, vinyl naphthalene/methacrylate copolymer, vinyl naphthalene/acrylate copolymer, acrylate alkyl ester/acrylate copolymer, methacrylate alkyl ester/methacrylate, styrene/methacrylate alkyl ester/methacrylate copolymer, styrene/ acrylate alkyl esteracrylate copolymer, styrene/methacrylate phenylester/methacrylate copolymer and styrene/methacrylate cyclohexyl ester/methacrylate copolymer.

The monomers which have a polyoxyethylene group and a hydroxy group can be suitably copolymerized for use as these polymers. The monomers having a cationically functional group such as N,N-dimethyl aminoethyl methacrylate, N,N-dimethyl amino ethyl acrylate, N,N-dimethylamino methacrylamide, N,N-dimethylamino acrylamide, N-vinyl pyrrole, N-vinyl pyridine, N-vinyl pyrrolidone, and N-vinyl imidazole can suitably be copolymerized for use in the invention so as to improve affinity with the pigment having an acidic functional group at the surface thereof and enhance dispersibility.

These copolymers may have any structure of a random copolymer, a block copolymer and a graft copolymer, or the like. Polystyrene sulphonic acid, polyacrylic acid, polymethacrylic acid, polyvinyl sulfonic acid, polyalginic acid, polyoxyethylene/polyoxypropylene/polyoxyethylene block copolymer, formalin condensate of naphthalene sulphonic acid, poly vinylpyrrolidone, polyethyleneimine, polyamines, polyamides, polyvinylimidazoline, aminoalkyl acrylate D acrylamide copolymer, chitosan, polyoxyethylene, polyoxyethylene fatty acid amide, polyvinyl alcohol, polyacrylamide, cellulose derivatives such as carboxymethyl cellulose and carboxyethyl cellulose polysaccharide, and the derivatives thereof may be used.

The hydrophilic group of the pigment dispersant is preferably a carboxylic acid or the salt of the carboxylic acid.

A neutralizing amount of the pigment dispersant is preferably 50% or more in terms of the acid value of the copolymer, and specifically preferably is 80% or more. The pigment dispersant has preferably a weight average molecular weight (Mw) of 2,000 to 15,000, and more preferably 3,500 to 10,000. A preferable structure and composition ratio of the hydrophilic moiety and the hydrophobic moiety can be preferably employed by selecting preferable combinations of the pigment and the solvent.

These pigment dispersants may be used singly or in combination. An addition amount of the pigment dispersant greatly depends on the kinds of pigments used, and the addition amount to the pigment is generally in a range of 0. 1 to 100% by mass, more preferably in a range of 1 to 70% by mass, and more preferably in a range of 3 to 50% by mass.

The ink may contain the surfactant. The surfactant is incorporated in the ink so as to adjust dispersibility of the pigment dispersant and a surface tension and wettability of the pigment ink, or to improve reliability upon solubilizing organic impurities in the ink for properly ejecting the ink from the nozzle.

Nonionic surfactants and anionic surfactants which do not adversely affect a dispersed state of the non-water-soluble colorant or a dissolved state of the water-soluble dye are preferably used as the surfactant for use in the invention. For example, polyoxyethylene nonylphenyl ether, polyoxyethylene octyl phenylether, polyoxyethylene dodecyl phenylether, polyoxyethylene alkylether, polyoxyethylene fatty acid ester, sorbitan fatty acid ester, polyoxyethylene sorbitan fatty acid ester, fatty acid alkylol amide, acetylene alcoholic ethylene oxide adduct, polyethylene glycol polypropylene glycol block copolymer, polyoxyethylene ether of glycerin ester, and polyoxyethylene ether of sorbitol ester or the like can be used as the nonionic surfactant.

For instance, alkyl benzene sulfonate, the alkyl phenyl sulfonate, alkyl naphthalene sulfonate, sulfuric ester salt of higher fatty acid ester, sulfonate and higher alkyl sulfosuccinate or the like can be used as the anionic surfactant.

Betaine, sulfobetaine, sulfobetaine and imidazoline or the like can be used as the ampholytic surfactant. Additionally, a silicon surfactant such as poly siloxane polyoxyethylene additament, a fluorine surfactant such as oxyethylene perfluoro alkylether and spiculisporic acid, rhamnolipid, a biosurfactant such as lysolecithin can be used. The surfactant for suitably use in the ink may be used singly or in combination. The addition amount can be adjusted depending on desired properties of the surface tension or the like.

If necessary, a pH buffering agent, an antioxidant, a fungicide, a viscosity modifier, an electro-conductive agent, a UV absorbent, a chelating agent, a water-soluble dye, a disperse dye, an oil-soluble dye and the like can be added to the ink. The content of these additives is preferably 20% by mass in the ink.

The ink can be obtained by adding the colorant in a prescribed amount to an aqueous solution, sufficiently stirring and dispersing the mixture using a disperser, removing coarse particles by centrifugation or the like, adding a prescribed solvent, an additive or the like to the obtained mixture and mixing while stirring, and subjecting the resultant mixture to filtration.

A commercially available disperser can be used. Examples of the dispersers include a colloid mill, a flow jet mill, a slusher mill, a high speed disperser, a ball mill, an attritor, a sand mill, a sand grinder, a ultra fine mill, an eiger motor mill, a dino mill, a pearl mill, an agitator mill, a cobol mill, a three roll, a two roll, an extruder, a kneader, a microfluidizer, laboratory homogenizer and a supersonic homogenizer. These dispersers may be used singly or in combination. A dispersing method without using any dispersing medium is preferably used to prevent contamination of inorganic impurities. In such a case, the microfluidizer and the supersonic homogenizer or the like are preferably used.

For instance, the ink which contains a self-dispersible pigment can be obtained by treatment of the surface-modifying the pigment, adding the modified pigment to water, sufficiently stirring and dispersing the resultant pigment using a disperser that is the same as the disperser, as necessary, removing coarse particles by centrifugal separation or the like, adding a prescribed solvent and additive or the like, and further stirring, mixing and then filtering.

A pH of the ink is preferably adjusted in a range of 3 to 11, and more preferably in a range of 4.5 to 9.5. The pH of the ink having an anionic free radical at a surface of the pigment is preferably adjusted in a range of 6 to 11, and more preferably in a range of 6 to 9.5, and more preferably in a range of 7.5 to 9.0. On the other hand, the pH of the ink having a cation free radical at a surface of the pigment is preferably adjusted in a range of 4.5 to 8.0, and more preferably in a range of 4.5 to 7.0.

A viscosity of the ink is preferably adjusted in a range of 1.5 to 5.0 mPa·s, and more preferably in a range of 1.5 to 4.0 mPa·s. When the viscosity of the ink is more than 5.0 mPa·s, the ink gradually penetrates into the recording sheet, whereby blur of inter-color mixing may occasionally take place. On the other hand, when the viscosity of the ink is less than 1.5 mPa·s, the ink too rapidly penetrates into the recording sheet, whereby the ink pigment and the anionic compound cannot be agglomerated. As a result, decreased density and blur of inter-color mixing may sometimes occur since the ink penetrates deeply into the recording sheet.

The surface tension of the ink can be controlled mainly by specifying the addition amount of the surfactant, and is preferably controlled in a range of 25 to 37 mN/m. When the surface tension is less than 25 mN/m, the ink rapidly penetrates into the recording sheet, and the colorant and the anionic water-soluble polymer may not cause agglomeration. Decreased density and blur of inter-color mixing may occur since the ink penetrates into the recording sheet. In contrast, when the surface tension is more than 37 mN/m, the ink may slowly penetrate into the recording sheet, and the drying property may be impaired.

Method for Recording Image Through Electrophotographic Process

The method for recording an image of the invention may be an electrophotographic process comprising the steps of: uniformly charging a surface of an electrostatic latent image-bearing body; exposing to light the surface of the electrostatic latent image-bearing body to form an electrostatic latent image; developing the electrostatic latent image formed on the surface of the electrostatic latent image-bearing body with a developer for an electrostatic image to thereby form a toner image; transferring the toner image onto a recording paper; and fixing the transferred toner image, and the recording sheet of the invention is used in this method.

The method for recording the image of the invention through an electrophotographic process can produce high quality images in a similar manner as employed in the conventional method for recording the image, and can suppress curling generated immediately after printing.

An image forming device used for the method for recording the image through the electrophotographic process of the invention is in no way limited to a particular method, insofar as the image forming device uses the electrophotographic process comprising the charging step, the exposing step, the developing step, the transferring step and the fixing step. For instance, a color image forming device of a developing system composed of four cycles forming the toner image by sequentially applying the developer that contains respective color toners to a photoreceptor, and a color image forming device (so-called “tandem machine”) which is provided with four developing units corresponding to the respective colors can be used by sequentially applying the developer that containins the respective color toners to the photoreceptor when the four color toners of cyan, magenta, yellow and black are used.

The toner used for forming images is not limited to a particular toner, insofar as the toner used is a conventionally known toner. However, for instance, a toner having a spherical shape and a small size distribution, and a toner including a binder resin having a low melting point to be fused at a low temperature for energy saving can be used from the viewpoint of capability of obtaining high-definition image.

### EXAMPLES

The present invention will now be illustrated by the following Examples. However, it is to be understood that the invention is not limited to the Examples. First, inks and recording sheets used in Examples and Comparative Examples will be described, and then, evaluation results when an image is recorded using various combinations of the inks and the recording sheets will be described.

(1) Preparation of Inks

Dye ink set 1 and pigment ink set 2 are prepared as the ink.

<Ink Set 1 (Color Dye Ink)>

Magenta Ink

Direct red 227 (10% by mass aqueous solution): 20 parts by mass

Ethylene glycol: 25 parts by mass

Urea: 5 parts by mass

Surfynol 465: 2 parts by mass

Deionized water is added to the above-indicated composition to make a total amount of 100 parts by mass, and stirred for 30 minutes. The resultant mixture is passed through a membrane filter having a mesh size of 1 μm. The ink has a surface tension of 31 mN/m and viscosity of 2.0 mPa·s.

Cyan Ink

Direct blue 142 (10% by mass aqueous solution): 20 parts by mass

Ethylene glycol: 25 parts by mass

Urea: 5 parts by mass

Surfynol 465: 2 parts by mass

Deionized water is added to the above-indicated composition to give a total amount of 100 parts by mass, and stirred for 30 minutes. The resultant mixture is passed through a membrane filter having a mesh size of 1 μm. The ink has a surface tension of 31 mN/m and viscosity is 2.0 mPa·s.

Yellow Ink

Direct yellow 144 (10% by mass aqueous solution): 20 parts by mass

Ethylene glycol: 25 parts by mass

Urea: 5 parts by mass

Surfynol 465: 2 parts by mass

Deionized water is added to the above-indicated composition to make a total amount of 100 parts by mass, and stirred for 30 minutes. The resulting mixture is passed through a membrane filter having a mesh size of 1 μm. The ink has a surface tension of 31 mN/m and viscosity of 2.0 mPa·s.

<Ink Set 2 (Pigment Ink)>

Black Ink

Surface-treated pigment (trade name: Cab-o-jet-300, manufactured by Cabot Corporation): 4 parts by mass

Styrene/maleate/sodium maleate copolymer: 0.5 parts by mass

Diethylene glycol: 20 parts by mass

Surfactant (trade name: Surfynol 465: manufactured by Nisshin

Chemicals Co., Ltd.): 0.5 parts by mass

Urea: 5 parts by mass

Ion exchanged water: 70 parts by mass

The above-indicated composition is stirred for 30 minutes. The resultant mixture is passed through a membrane filter having a mesh size of 1 μm. The ink has a surface tension of 32 mN/m and viscosity of 2.8 mPa·s.

Cyan Ink

Surface-treated pigment (trade name: IJX-253, manufactured by Cabot Corporation): 4 parts by mass

Styrene/maleate/sodium maleate copolymer: 0.5 parts by mass

Diethylene glycol: 20 parts by mass

Surfactant (trade name: Surfynol 465: manufactured by Nisshin

Chemicals Co., Ltd.): 0.5 parts by mass

Urea: 5 parts by mass

Ion exchanged water: 70 parts by mass

The above-indicated composition is stirred for 30 minutes. The resulting mixture is passed through a membrane filter having a mesh size of 1 μm. The ink has a surface tension of 32 mN/m and viscosity of 2.5 mPa·s.

Magenta Ink

Surface-treated pigment (trade name: IJX-266, manufactured by Cabot Corporation): 4 parts by mass

Styrene/maleate/sodium maleate copolymer: 0.5 parts by mass

Diethylene glycol: 20 parts by mass

Surfactant (trade name: Surfynol 465: manufactured by Nisshin Chemicals Co., Ltd.): 0.5 parts by mass

Urea: 5 parts by mass

Ion exchanged water: 70 parts by mass

The above-indicated composition is stirred for 30 minutes. The resultant mixture is passed through a membrane filter having a mesh size of 1 μm. The ink has a surface tension of 33 mN/m and viscosity of 2.5 mPa·s.

Yellow Ink

Surface-treated pigment (trade name: IJX-273, manufactured by Cabot Corporation): 4 parts by mass

Styrene/maleate/sodium maleate copolymer: 0.5 parts by mass

Diethylene glycol: 20 parts by mass

Surfactant (trade name: Surfynol 465: manufactured by Nisshin Chemicals Co., Ltd.): 0.5 parts by mass

Urea: 5 parts by mass

Ion exchanged water: 70 parts by mass

The above-indicated composition is stirred for 30 minutes. The resultant mixture is passed through a membrane filter having a mesh size of 1 μm. The ink has a surface tension of 33 mN/m and viscosity of 2.7 mPa·s.

(2) Preparation of Recording Sheet

The following recording sheets (1) to (9) are prepared.

<Recording Sheet (1)>

A 1% aqueous dispersion of a nonionic surfactant (trade name: Surfynol 440: HLB 8, manufactured by Nisshin Chemicals Co., Ltd.) is size-pressed on Green 100 sheet (a mechanical woodpulp recycled paper) manufactured by Fuji Xerox Office Supply Co., Ltd. using a test size press manufactured by Kumagaya Riki such that a content of the nonionic surfactant is 2 g/m². The resultant sheet is dried in KRK rotary dryer manufactured by Kumagaya Riki at 110° C. and 0.5 m/min to obtain a recording sheet (1) having a basis weight of 70 g/m². A CD expanding and shrinking ratio of the recording sheet (1) is 0.42%.

<Recording Sheet (2)>

A 1% aqueous dispersion of a nonionic surfactant (trade name: Surfynol 465: HLB13, manufactured by Nisshin Chemicals Co., Ltd.) is size-pressed on Green 100 sheet (a mechanical woodpulp recycled paper) manufactured by Fuji Xerox Office Supply Co., Ltd. using a test size press manufactured by Kumagaya Riki such that a content of the nonionic surfactant is 3 g/m². The resultant sheet is dried in KRK rotary dryer manufactured by Kumagaya Riki at 110° C. and 0.5 m/min to obtain a recording sheet (2) having a basis weight of 71 g/m². A CD expanding and shrinking ratio of the recording sheet (2) is 0.50%.

<Recording Sheet (3)>

A 1% aqueous dispersion of a nonionic surfactant (trade name: Surfynol 440: HLB 8, manufactured by Nisshin Chemicals Co., Ltd.) is size-pressed on J sheet (a woodfree paper for color-printing) manufactured by Fuji Xerox Office Supply Co., Ltd. using a test size press manufactured by Kumagaya Riki such that a content of the nonionic surfactant is 2 g/m². The resultant sheet is dried in KRK rotary dryer manufactured by Kumagaya Riki at 110° C. and 0.5 m/min to obtain a recording sheet (3) having a basis weight of 84 g/m². A CD expanding and shrinking ratio of the recording sheet (3) is 0.34%.

<Recording Sheet (4)>

A 1% aqueous dispersion of a nonionic surfactant (trade name: Surfynol 485: HLB 17, manufactured by Nisshin Chemicals Co., Ltd.) is size-pressed on Green 100 paper (a mechanical woodpulp recycled paper) manufactured by Fuji Xerox Office Supply Co., Ltd. using a test size press manufactured by Kumagaya Riki such that a content of the nonionic surfactant is 2 g m². The resultant sheet is dried in KRK rotary dryer manufactured by Kumagaya Riki at 110° C. and 0.5 m/min to obtain a recording sheet (4) having a basis weight of 70 g/m². A CD expanding and shrinking ratio of the recording sheet (4) is 0.58%.

<Recording Sheet (5)>

A 1% aqueous dispersion of a nonionic surfactant (trade name: Surfynol 440: HLB 8, manufactured by Nisshin Chemicals Co., Ltd.) is size-pressed on Green 100 paper (a mechanical woodpulp recycled paper) manufactured by Fuji Xerox Office Supply Co., Ltd. using a test size press manufactured by Kumagaya Riki such that a content of the nonionic surfactant is 0.05 g/m². The resultant sheet is dried in KRK rotary dryer manufactured by Kumagaya Riki at 110° C. and 0.5 m/min to obtain a recording sheet (5) having a basis weight of 68 g/m². A CD expanding and shrinking ratio of the recording sheet (5) is 0.60%.

<Recording Sheet (6)>

A 1% aqueous dispersion of a cationic surfactant (trade name: Cation MA, manufactured by Nippon Oil & Fats Co., Ltd.) is size-pressed on Green 100 paper (a mechanical woodpulp recycled paper) manufactured by Fuji Xerox Office Supply Co., Ltd. using a test size press manufactured by Kumagaya Riki such that a content of the cationic surfactant is 2 g/m². The resultant sheet is dried in KRK rotary dryer manufactured by Kumagaya Riki at 110° C. and 0.5 m/min to obtain a recording sheet (6) having a basis weight of 70 g/m². A CD expanding and shrinking ratio of the recording sheet (6) is 0.57%.

<Recording Sheet (7)>

A 2% aqueous dispersion of a nonionic surfactant (trade name: Surfynol 440: HLB 8, manufactured by Nisshin Chemicals Co., Ltd.) is size-pressed on Green 100 paper (a mechanical woodpulp recycled paper) manufactured by Fuji Xerox Office Supply Co., Ltd. by a test size press manufactured by Kumagaya Riki such that a content of the nonionic surfactant is 7 g/m². The resultant sheet is dried in KRK rotary dryer manufactured by Kumagaya Riki at 110° C. and 0.5 m/min to obtain a recording sheet (7) having a basis weight of 75 g/m². A CD expanding and shrinking ratio of recording sheet (7) is 0.31%.

<Recording Sheet (8)>

An aqueous dispersion containing a nonionic surfactant (trade name: Surfynol 440: HLB 8, manufactured by Nisshin Chemicals Co., Ltd.) at 1% and calcium chloride as a polyvalent metal salt at 1% is size-pressed on Green 100 paper (a mechanical woodpulp paper) manufactured by Fuji Xerox Office Supply Co., Ltd. using a test size press manufactured by Kumagaya Riki such that a dry weight is 4 g/m². The resultant sheet is dried in KRK rotary dryer manufactured by Kumagaya Riki at 110° C. and 0.5 m/min to obtain a recording sheet (8) having a basis weight of 72 g/m². A CD expanding and shrinking ratio of recording sheet (8) is 0.38%.

<Recording Sheet (9)>

An aqueous dispersion containing calcium chloride as a polyvalent metal salt at 1% is size-pressed on Green 100 paper (a mechanical woodpulp recycled paper) manufactured by Fuji Xerox Office Supply Co., Ltd. using a test size press manufactured by Kumagaya Riki such that a dry weight is 2 g/m². The resultant sheet is dried in KRK rotary dryer manufactured by Kumagaya Riki at 110° C. and 0.5 m/min to obtain a recording sheet (9) having a basis weight of 70 g/m². A CD expanding and shrinking ratio of recording sheet (9) is 0.55%.

### Examples 1-5 and Comparative Examples 1-4

The thus prepared inks and recording sheets are evaluated, in various combinations as shown in Table 1, for the following properties.

TABLE 1

| | | Recording Sheet | | | | |
|---|---|---|---|---|---|---|
| | Ink | | Surfactant | | Expanding and | Content of Polyvalent |
| | No. | No. | HLB | Content (g/m²) | Shrinking Ratio (%) | Metal (g/m²) |
| Example 1 | Ink set (1) | Recording sheet (1) | 8 | 2 | 0.42 | 0 |
| Example 2 | Ink set (1) | Recording sheet (2) | 13 | 3 | 0.50 | 0 |
| Example 3 | Ink set (2) | Recording sheet (3) | 8 | 2 | 0.34 | 0 |
| Example 4 | Ink set (2) | Recording sheet (8) | 8 | 2 | 0.38 | 2 |
| Example 5 | Ink set (1) | Recording sheet (7) | 8 | 7 | 0.31 | 0 |
| Comparative | Ink set (1) | Recording sheet (4) | 17 | 2 | 0.58 | 0 |
| Example 1 | | | | | | |
| Comparative | Ink set (2) | Recording sheet (5) | 8 | 0.05 | 0.60 | 0 |
| Example 2 | | | | | | |
| Comparative | Ink set (2) | Recording sheet (9) | — | 0 | 0.55 | 2 |
| Example 3 | | | | | | |
| Comparative | Ink set (1) | Recording sheet (6) | Cation | 2 | 0.57 | 0 |
| Example 4 | | | | | | |

(1) Evaluation of Recording Through Ink Jet Process

The recording sheets of Examples and the recording sheets of Comparative Examples are evaluated for recording performances in the following manner. The results are summarized in Table 2.

Characters are printed and evaluated using a thermal ink jet recording device, which is used for multi-pass printing and provided with four recording heads, in an atmosphere of 23° C. and 50% RH. An ink discharging nozzle pitch of a printing head is 800 dpi, an ink discharging nozzle number is 256, a discharged amount is about 15 pl, and a head scanning speed is about 28 cm/second.

Evaluation of Curling Generated Immediately After Printing

A margin of 5 mm is provided in a recording sheet of a postcard size, and a solid image of Magenta 100% is printed. Hanging curling generated at a face opposite to the printed face immediately after printing is measured. Measured values are converted in terms of a curvature to be evaluated. Evaluation criteria are as follows, in which A and B indicate acceptable levels.

A: Less than 20 m⁻¹.

B: 20 m⁻¹ or more and less than 35 m⁻¹.

C: 35 m⁻¹ or more and less than 50 m⁻¹.

D: 50 m⁻¹ or more.

Evaluation of Waviness Generated Immediately After Printing

A solid image (Blue) of secondary color 100% of 2 cm×2 cm is printed at a center of a recording sheet having a postcard size. A maximum height of waviness generated immediately after printing is measured by a laser displacement meter. Evaluation criteria are as follows, in which A and B indicate acceptable levels.

A: Less than 1 mm;

B: 1 mm or more and less than 2 mm;

C: 2 mm or more and less than 3 mm; and

D: 3 mm or more.

Evaluation of Curling Generated After Being Left Standing for Drying

A margin of 5 mm is provided on a recording sheet of a postcard size, and a solid image of Magenta 100% is printed. The printed sheet is left standing with a printed surface facing upward at 23° C. and 50% RH, and then assessed for hanging curling generated after it is left standing for 100 hours after printing. Measured values are converted in terms of a curling curvature to be evaluated. Evaluation criteria are as follows, in which A and B indicate acceptable levels.

A: Less than 30 m⁻¹;

B: 30 m⁻¹ or more and less than 75 m⁻¹; and

C: 75 m⁻¹ or more.

Evaluation of Image Quality

An image is printed on a recording sheet having a postcard size such that Yellow 100% is printed adjacent to Black 100%, and a boundary of the two colors is evaluated according to the following standards.

A: Blur of inter-color mixing does not occur, and color development is good;

B: Blur of inter-color mixing does not occur;

C: Blur of inter-color mixing is partly generated.

D: Blur of inter-color mixing seriously occurs in an entire image.

(2) Evaluation of Image Recording through Electrophotographic Process

Evaluation of Curling Generated Immediately After Printing

A margin of 5 mm is provided in a recording sheet having a postcard size, and a solid image of Magenta 100% is recorded (an image is recorded through an electrophotographic process), and assessed for hanging curling generated immediately after printing. Measured values are converted in terms of a curvature to be evaluated. Evaluation criteria are as follows, in which A and B indicate acceptable levels. The results are summarized in Table 2.

The image recording carried out through the electrophotographic process is an image recording method which comprises a charging step, an exposing step, a developing step, a transferring step and a fixing step.

A: Less than 10 m⁻¹;

B: 10 m⁻¹ or more and less than 20 m⁻¹;

C: 20 m⁻¹ or more and less than 35 m⁻¹; and

D: 35 m⁻¹ or more.

TABLE 2

| | Ink Jet Recording Process | | | | Electrophotographic |
|---|---|---|---|---|---|
| | Immediately | | After Being Left | | Recording Process |
| | after Printing | | Standing for Drying | | Curling Immediately |
| | Curling | Waviness | Curling | Image Quality | After Printing |
| Example 1 | ◯ | ⊚ | ◯ | ◯ | ◯ |
| Example 2 | ◯ | ◯ | ◯ | ◯ | ◯ |
| Example 3 | ⊚ | ⊚ | ◯ | ◯ | ⊚ |
| Example 4 | ◯ | ⊚ | ⊚ | ⊚ | ⊚ |
| Example 5 | ⊚ | ⊚ | ◯ | Δ | ◯ |
| Comparative | X | X | X | ◯ | Δ |
| Example 1 | | | | | |
| Comparative | X | X | ◯ | ◯ | Δ |
| Example 2 | | | | | |
| Comparative | X | X | ◯ | ⊚ | Δ |
| Example 3 | | | | | |
| Comparative | X | X | X | ◯ | Δ |
| Example 4 | | | | | |

Table 2 shows the results of Examples, revealing that the recording sheets of the invention suppress curling and waviness generated immediately after printing and also suppress curling generated after being left standing for drying, when the image is recorded through the ink jet process. Table 2 also reveals that when the image is printed through the electrophotographic process, the recording sheet of the invention suppresses curling generated immediately after printing.

As detailed above, the present invention provides a recording sheet whose both surfaces can be subjected to printing through an ink jet recording process, owing to its ability to suppress curling and waviness generated immediately after printing, as well as to suppress curling generated after being left to stand for drying. The present invention also provides a recording sheet that can suppress curling generated immediately after printing when an image is printed through an electrophotographic recording process. The present invention further provides a method for recording an image using the recording sheet.

What is claimed is:

1. A recording sheet comprising regular paper, that contains as a raw material at least a cellulose pulp, having added thereto a nonionic surfactant having an HLB value of higher than 6 and 13 or smaller in an amount of 0.1 g/m² or more.

2. The recording sheet according to claim 1, wherein the nonionic surfactant has an HLB value of higher than 6 and 11 or smaller.

3. The recording sheet according to claim 1, wherein the nonionic surfactant is added to the regular paper in an amount ranging from 0.1 to 5.0 g/m².

4. The recording sheet according to claim 1, further comprising a polyvalent metal salt added to the regular paper.

5. The recording sheet according to claim 4, wherein an amount of the polyvalent metal salt added to the regular paper ranges from 0.1 to 2.0 g/m².

6. The recording sheet according to claim 1, comprising a CD expanding and shrinking ratio ranging from 0.25 to 0.50%.

7. The recording sheet according to claim 1, wherein the cellulose pulp comprises at least a chemical pulp.

8. The recording sheet according to claim 1, comprising a basis weight ranging from 60 to 128 g/m².

9. A method for recording an image on a recording sheet through an ink jet process by discharging ink droplets onto the recording sheet,
wherein the recording sheet comprises regular paper, that contains as a raw material at least a cellulose pulp, having added thereto a nonionic surfactant having an HLB value of higher than 6 and 13 or smaller in an amount of 0.1 g/m² or more.

10. The method for recording an image according to claim 9, wherein the ink has a surface tension ranging from 25 to 37 mN/m.

11. The method for recording an image according to claim 9, wherein the ink comprises at least a colorant, an anionic water-soluble polymer, a water-soluble organic solvent, and water.

12. The method for recording an image according to claim 9, wherein the ink comprises black ink containing a pigment as the colorant.

13. The method for recording an image according to claim 9, wherein the ink comprises any one of cyan, magenta and yellow inks containing a dye as the colorant.

14. The method for recording an image according to claim 9, wherein the ink comprises any one of cyan, magenta and yellow inks containing a pigment which acquires hydrophilicity by adding to a hydrophobic pigment a dispersant having a hydrophilic group.

15. The method for recording an image according to claim 9, wherein the ink comprises any one of cyan, magenta and yellow inks containing a self-dispersible pigment.

16. The method for recording an image according to claim 9, wherein the ink has a surface tension ranging from 25 to 37 mN/m.

17. The method for recording an image according to claim 9, wherein the ink has a pH ranging from 3 to 11.

18. The method for recording an image according to claim 9, wherein the ink has a viscosity ranging from 1.5 to 5.0 mPa·s.

19. A method for recording an image on a recording sheet through an electrophotographic process comprising:
uniformly charging a surface of an electrostatic latent image-bearing body;
exposing to light the surface of the electrostatic latent image-bearing body to form an electrostatic latent image;
developing the electrostatic latent image formed on the surface of the electrostatic latent image-bearing body with a developer for an electrostatic image to thereby form a toner image;
transferring the toner image onto the recording sheet; and
fixing the transferred toner image,
wherein the recording sheet comprises regular paper, that contains as a raw material at least a cellulose pulp, having added thereto a nonionic surfactant having an HLB value of higher than 6 and 13 or smaller in an amount of 0.1 g/m² or more.

20. The method for recording an image according to claim 19, wherein the toner comprises cyan, magenta, yellow and black color toners.
